(19) United States
(12) Patent Application Publication
(10) Pub. No.: US 2013/0188115 A1
(43) Pub. Date: Jul. 25, 2013

(54) Backlight Module and LCD Device

(71) Applicants: Chong Huang, Shenzhen (CN); Yuchun Hsiao, Shenzhen (CN); Yicheng Kuo, Shenzhen (CN)

(72) Inventors: Chong Huang, Shenzhen (CN); Yuchun Hsiao, Shenzhen (CN); Yicheng Kuo, Shenzhen (CN)

(21) Appl. No.: 13/498,325

(22) PCT Filed: Feb. 28, 2012
(86) PCT No.: PCT/CN12/71716

§ 371 Date: Mar. 26, 2012

(30) Foreign Application Priority Data
Jan. 20, 2012 (CN) 201210029819.1

(51) Int. Cl. G02F 1/13357; G09F 13/04; F21V 8/00; G09F 13/14

(52) U.S. Cl. 349/65; 349/62; 362/97.1; 362/97.4; 362/615; 362/628

(57) ABSTRACT

The invention discloses a backlight module and an LCD device. The backlight module includes an optical assembly at the edge of which an independent positioning lug for fixing the optical assembly is fixed, and the optical assembly is an LGP, a reflector sheet, or an optical film. The invention splits the optical assembly and the positioning part apart, and the optical assembly may be processed into a normal rectangular structure without secondary cutting for forming a positioning part, thereby reducing the waste of materials. The positioning lug has a small size and can be processed with the leftover material of the cut optical assembly.

### TECHNICAL FIELD

The invention relates to the field of liquid crystal displays (LCDs), and more particularly to a backlight module and an LCD device.

### BACKGROUND

Conventional TFT-LCD devices mainly include: a bezel, a panel, and a backlight module. The panel is fixed to the backlight module via the bezel. However, the backlight module sequentially includes from the bottom a backplane and an optical assembly. The optical assembly sequentially includes a reflector sheet, a light guide plate (LGP), and an optical film.

Pat. Pub. No. U.S. 2010/0296310A1, published on Nov. 25, 2010, discloses an LGP of a display device including the LGP and a backplane, wherein, multiple grooves are cut from the LGP, the backplane is provided with positioning columns fitting with the grooves, and the LGP is fixed by the positioning columns.

Pat. Pub. No. CN1629694A, published on Jun. 22, 2005, discloses an optical film suitable for being fixed on a frame. The optical film mainly includes a body and at least one positioning part. The positioning part protrudes from edges of the body and corresponds to positioning columns on the frame. In addition, the positioning part has an opening at the edge thereof connected with the edges of the body. The change of the position of the opening can prevent the optical film from falling from the frame. Through changing the position of the opening arranged on the positioning part of the optical film, the formation yield of the optical film is guaranteed and the falling of the opening of the optical film from the positioning columns due to gravity is prevented. Thus, the optical film is fixed to the frame effectively, which is beneficial for application.

Disadvantages of conventional optical assemblies are summarized below: these optical assemblies need cutting for the second time to form a positioning part, during which part of materials may be cut off, causing the waste.

### SUMMARY

One aim of the invention is to provide a backlight module and an LCD device for reducing waste caused by cutting of an optical assembly.

The aim of the invention is achieved by the following technical schemes:

A backlight module comprises an optical assembly, independent positioning lugs for fixing the optical assembly is fixed at the edge of the optical assembly, and the optical assembly is an LGP, a reflector sheet, or an optical film.

Preferably, one end of the positioning lug fixing to the optical assembly is a root part, and the other end opposite to the root part is a fixing part; the root part of the positioning lug is fixedly connected with a side adjacent to the light emitting surface of the optical assembly. The positioning lug is divided into two parts, and the root part fixed to the optical assembly may be fixed in multiple forms. Likewise, the positioning lug may also be fixed in multiple forms via the fixing part, and both parts can be fixed in multiple forms according to specific conditions. The positioning lug is arranged on the same level of the optical assembly, which will not increase the thickness of the optical assembly and will facilitate lightening and thinning of the module; the technical scheme is particularly suitable for an LGP.

Preferably, the thickness of the positioning lug is consistent with that of the optical assembly, which not only ensures the maximization of the contact area between the positioning lug and the LGP, but also ensures that the thickness of the LGP will not be increased, thereby facilitating the lightening and thinning of the LCD device.

Preferably, one end of the positioning lug fixing to the LGP is a root part, and the other end opposite to the root part is a fixing part; a groove is arranged on the side of the LGP, and the root part of the positioning lug is embedded into the groove for fixing. This is another fixing form on the side. The arrangement of the groove enlarges the contact area between the positioning lug and the LGP and thus improves the fixing strength.

Preferably, the bottom of the groove is wider than an opening thereof; correspondingly, the root part of the positioning lug is provided with a convex member matching with the bottom of the groove. The bottom of the groove is wider than the opening thereof, and a jump hook structure is formed after the root part of the matching positioning lug is embedded, which prevents the positioning lug from deviating from the horizontal direction and thus further increases the fixing reliability.

Preferably, the groove is of T-shaped. This is a specific groove structure of which the bottom is wider than the opening thereof, and the lateral side and the vertical side of “T” are perpendicular to each other, which produces a high positioning intensity.

Preferably, one end of the positioning lug fixing to the LGP is a root part, and the other end opposite to the root part is a fixing part; the fixing part of the positioning lug is provided with an installing hole. After the installing hole is arranged, the positioning lug may be fixed to the backplane or the frame of the LCD device in a screw fixing mode, which is convenient for assembly and disassembly.

Preferably, one end of the positioning lug fixing to the optical assembly is a root part, and the other end opposite to the root part is a fixing part; the root part of the positioning lug is fixed at the edge of the light emitting surface of the optical assembly or at the edge of the surface opposite to the light emitting surface of the optical assembly. The technical scheme is suitable for application to a reflector sheet and an optical film, in which the positioning lug overlaps the bottom surface or the top surface, and the overlapping area therebetween is large and adjustable during fixing. Generally, the larger the overlapping area, the higher the fixing strength. Therefore, the fixing of the positioning lug to the optical assembly is more reliable.

Preferably, the thickness of the positioning lug is consistent with that of the reflector sheet or the optical film. For equal thicknesses, the lug can be made of the same material remained by processing of the reflector sheet or the optical film, thereby saving materials.

An LCD device comprises one of the aforementioned backlight modules.

The invention splits the optical assembly and the positioning part apart, and the optical assembly can be processed into a normal rectangular structure without secondary cutting for forming the positioning part, thereby reducing the waste of the material. The positioning lug has a small size and can be produced by the leftover material of the cut optical assembly.

### BRIEF DESCRIPTION OF FIGURES

FIG. 1 is an integral schematic diagram of the invention;

FIG. 2 is a schematic diagram of example 1 of the invention;

FIG. 3 is a schematic diagram of example 2 of the invention;

FIG. 4 is a partial exploded view of example 2 of the invention;

FIG. 5 is a partial enlarged view of example 2 of the invention;

FIG. 6 is a sectional view of the invention along X-X′ in FIG. 5;

FIG. 7 is a schematic diagram of example 3 of the invention;

Wherein: 100. Optical assembly; 110. Groove; 200. Positioning lug; 210. Installing hole; 220. Root part; 230. Convex member.

### DETAILED DESCRIPTION

The invention will further be described in detail in accordance with the figures and the preferred examples.

An LCD device comprises a backlight module, the backlight module comprises an optical assembly 100, and an independent positioning lug 200 is fixed at the edge of the optical assembly 100. The optical assembly can be one or more selected from the group consisting of a reflector sheet, an optical film, and an LGP. The positioning lug 200 is an independent small sheet structure, which can be made of the same material as that of the optical assembly and other material like PET and form an integrated structure with the optical assembly 100 through splicing and pasting. The positioning lug 200 comprises a root part 220 fixed to the optical assembly 100, and the other end opposite to the root part 220 is a fixing part for fixing the positioning lug 200. The positioning lug 200 is divided into two parts. The root part 220 fixed to the optical assembly can be fixed in multiple forms, and similarly, the positioning lug 200 can be fixed in multiple forms by the fixing part, both of which can be flexibly configured according to specific conditions.

### EXAMPLE 1

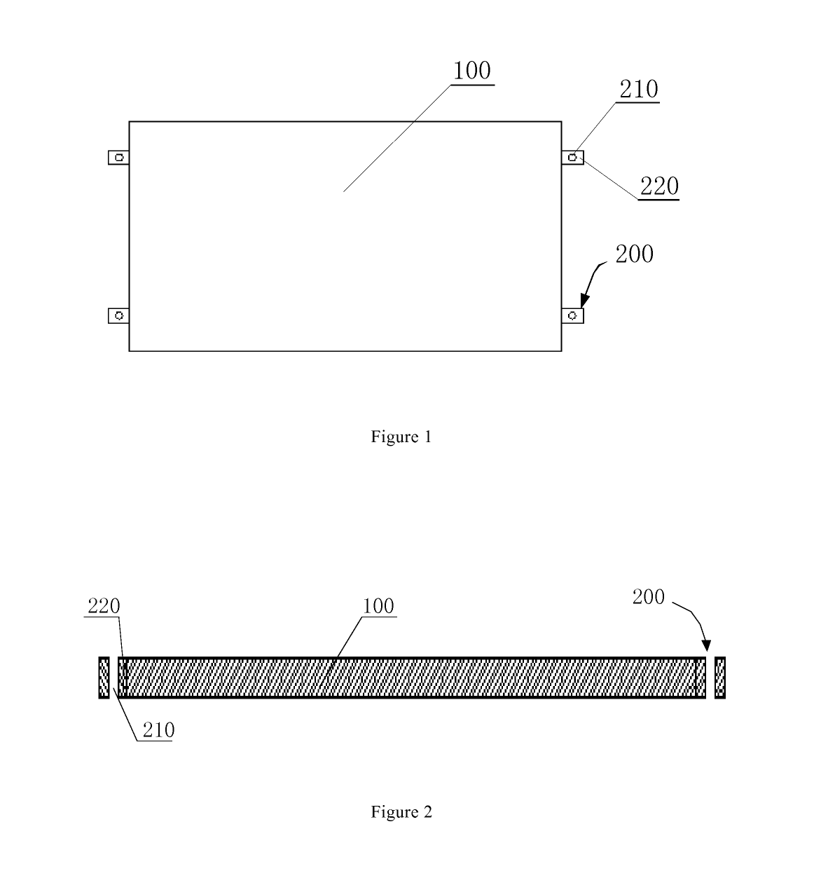

As shown in FIG. 1 and FIG. 2, the root part 220 of the positioning lug 200 is directly fixed on a side adjacent to the light emitting surface of the optical assembly 100 by pasting etc., so that the positioning lug 200 is arranged on the same level of the optical assembly 100, particularly when the thickness of the positioning lug is consistent with that of the optical assembly, which increases the connection strength without increasing the thickness of the optical assembly. The technical scheme is particularly suitable for the fixing of the LGP and facilitates the lightening and thinning of the LCD device.

An installing hole 210 is arranged on the fixing part of the positioning lug 200, thereby facilitating the fixing of the positioning lug 200 to the backplane or the frame of the LCD device by screw fixing and facilitating the assembly and disassembly.

### EXAMPLE 2

To increase the fixing strength, on the basis of the example 1, a groove 110 is arranged on the side of the optical assembly 100. The root part 220 of the positioning lug 200 is embedding into the groove 110 for fixing. Thus, the contact area between the positioning lug 200 and the optical assembly 100 is enlarged and thus the fixing strength enhanced.

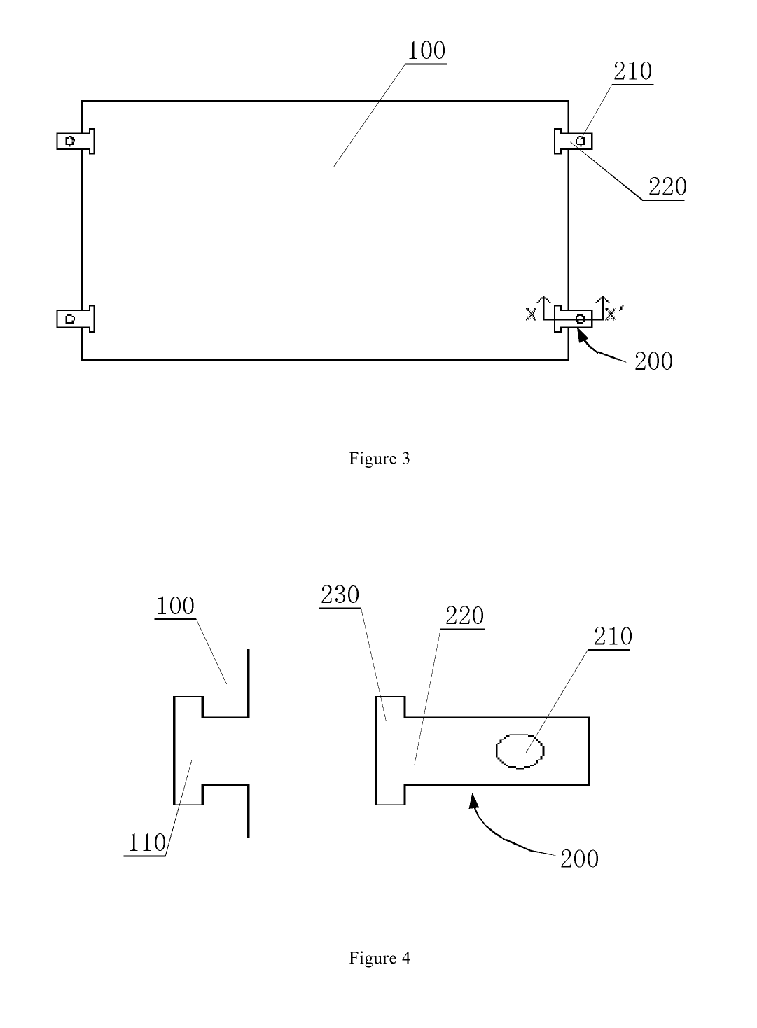

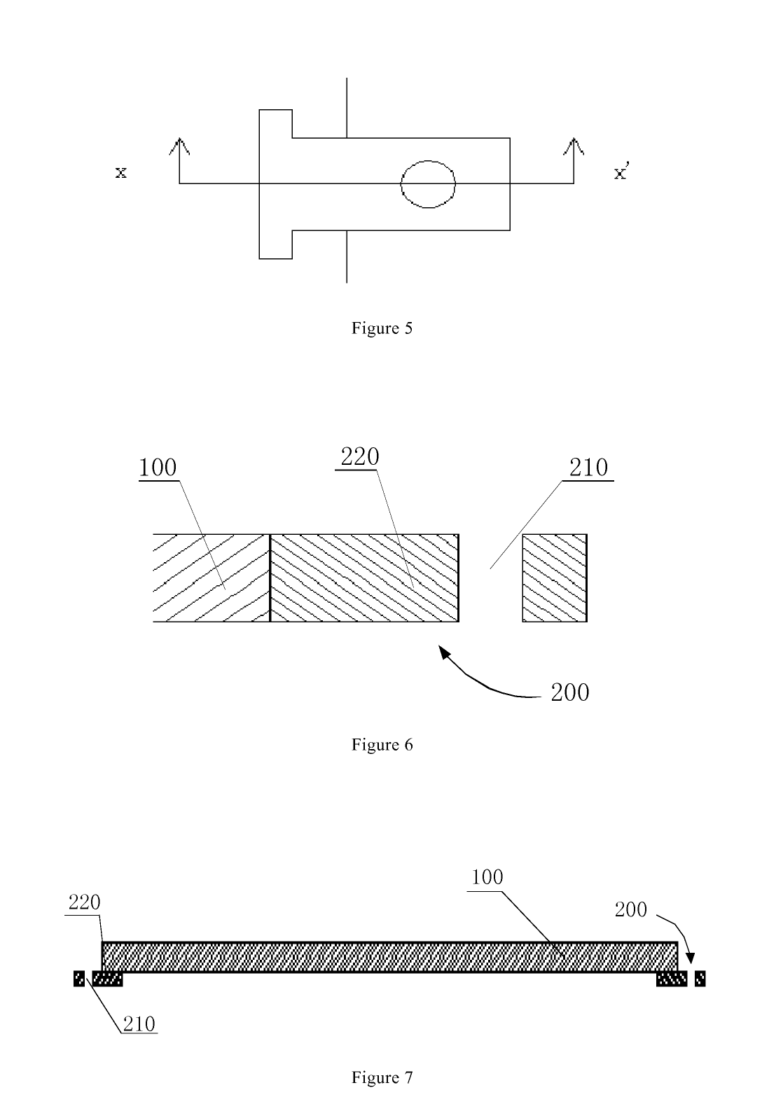

Further, as shown in FIG. 3-6, the bottom of the groove 110 is wider than an opening thereof; correspondingly, the root part 220 of the positioning lug 200 is provided with a convex member matching with the bottom of the groove 110. The bottom of the groove 110 is wider than the opening thereof, and a jump hook structure is formed after the root part 220 of the matching positioning lug 200 is embedded, which prevents the positioning lug 200 from deviating from the horizontal direction and increases the fixing reliability, thereby facilitating the fixing.

The groove 110 can be a T-shaped structure in which the lateral side and the vertical side are perpendicular to each other to produce a high positioning intensity. Optionally, other structures like wedge of which the bottom is wider than the opening is practicable.

An installing hole 210 is arranged on the fixing part of the positioning lug 200, thereby facilitating the fixing of the positioning lug 200 to the backplane or the frame of the LCD device by screw fixing and facilitating the assembly and disassembly.

### EXAMPLE 3

As shown in FIG. 1 and FIG. 7, the root part 220 of the positioning lug 200 is fixed at the edge of the light emitting surface of the optical assembly 100 or at the edge of the surface opposite to the light emitting surface of the optical assembly 100 by pasting etc., this is an embodiment particularly suitable for application to a reflector sheet or an optical film, in which the positioning lug 200 overlaps the bottom surface or the top surface, and the overlapping area therebetween is adjustable during fixing. Generally, the larger the overlapping area, the higher the fixing strength. Thus, the fixing of the positioning lug 200 to the optical assembly 100 is more reliable. Because the reflector sheet and the optical film are thin and the thickness of the positioning lug is difficult to reduce, the lug may be made of the same material remained by processing of the reflector sheet or the optical film. Thus, the material is saved and the thickness of the positioning lug 200 is consistent with that of the reflector sheet or the optical film.

An installing hole 210 is arranged on the fixing part of the positioning lug 200, thereby facilitating the fixing of the positioning lug 200 to the backplane or the frame of the LCD device by screw fixing and facilitating the assembly and disassembly.

The invention is described in accordance with the examples above. However, this invention is not limited to these examples. Within the range of the technical spirit of the patent, the shape structure and the position of the positioning lug can be changed in accordance with different machines. For the ordinary technical personnel of the technical field of the invention, on the premise of keeping the conception of the invention, the technical personnel can also make simple deductions or replacements, and all of which should be considered to belong to the protection scope of the invention.

1. A backlight module, comprising: an optical assembly, wherein said optical assembly is a reflector sheet, and an independent positioning lug for fixing the reflector sheet is fixed at the edge of said reflector sheet.

2. The backlight module of claim 1, wherein one end of said positioning lug fixing to the reflector sheet is a root part, and the other end opposite to the root part is a fixing part; the root part of said positioning lug is fixed at the edge of the light emitting surface of said reflector sheet or at the edge of the surface opposite to the light emitting surface of said reflector sheet.

3. The backlight module of claim 2, wherein the thickness of said positioning lug is consistent with that of said reflector sheet.

4. An LCD device, comprising: a backlight module, wherein said backlight module comprises a reflector sheet, and an independent positioning lug for fixing the reflector sheet is fixed at the edge of said reflector sheet.

5. The LCD device of claim 4, wherein one end of said positioning lug fixing to the reflector sheet is a root part, and the other end opposite to the root part is a fixing part; the root part of said positioning lug is fixed at the edge of the light emitting surface of said reflector sheet or at the edge of the surface opposite to the light emitting surface of said reflector sheet.

6. The LCD device of claim 5, wherein the thickness of said positioning lug is consistent with that of said reflector sheet.

7. A backlight module, comprising: an optical assembly, wherein the optical assembly is an optical film, and an independent positioning lug for fixing the optical film is fixed at the edge of said optical film.

8. The backlight module of claim 7, wherein one end of said positioning lug fixing to the optical film is a root part, and the other end opposite to the root part is a fixing part; the root part of said positioning lug is fixed at the edge of the light emitting surface of said optical film or at the edge of the surface opposite to the light emitting surface of said optical film.

9. The backlight module of claim 8, wherein the thickness of said positioning lug is consistent with that of said optical film.

10. An LCD device, comprising: a backlight module, wherein said backlight module comprises an optical film, and an independent positioning lug for fixing the optical film is fixed at the edge of said optical film.

11. The LCD device of claim 10, wherein one end of said positioning lug fixing to the optical film is a root part, and the other end opposite to the root part is a fixing part; the root part of said positioning lug is fixed at the edge of the light emitting surface of said optical film or at the edge of the surface opposite to the light emitting surface of said optical film.

12. The LCD device of claim 11, wherein the thickness of said positioning lug is consistent with that of said optical film.

13. A backlight module, comprising: an optical assembly, wherein said optical assembly is an LGP, and an independent positioning lug for fixing the LGP is fixed at the edge of said LGP.

14. The backlight module of claim 13, wherein one end of said positioning lug fixing to the LGP is a root part, and the other end opposite to the root part is a fixing part; the root part of said positioning lug is fixedly connected with a side adjacent to the light emitting surface of said LGP.

15. The backlight module of claim 14, wherein the thickness of said positioning lug is consistent with that of said LGP.

16. The backlight module of claim 13, wherein one end of said positioning lug fixing to the LGP is a root part, and the other end opposite to the root part is a fixing part; a groove is arranged on the side of said LGP, and the root part of said positioning lug is embedded into the groove for fixing.

17. The backlight module of claim 16, wherein a bottom of said groove is wider than an opening thereof; correspondingly, the root part of said positioning lug is provided with a convex member matching with the bottom of said groove.

18. The backlight module of claim 17, wherein said groove is of T-shape.

19. An LCD device, comprising: a backlight module, wherein said backlight module comprises an optical assembly; said optical assembly is an LGP, and an independent positioning lug for fixing the LGP is fixed at the edge of said LGP.

20. The LCD device of claim 19, wherein one end of said positioning lug fixing to the LGP is a root part, and the other end opposite to the root part is a fixing part; the root part of said positioning is fixedly connected with a side adjacent to the light emitting surface of said LGP.

21. The LCD device of claim 20, wherein the thickness of said positioning lug is consistent with that of said LGP.

22. The LCD device of claim 19, wherein one end of said positioning lug fixing to the LGP is a root part, and the other end opposite to the root part is a fixing part; a groove is arranged on the side of said LGP, and the root part of said positioning lug is embedded into the groove for fixing.

23. The LCD device of claim 19, wherein the bottom of the groove is wider than an opening thereof; correspondingly, the root part of said positioning lug is provided with a convex member matching with the bottom of said groove.

24. The LCD device of claim 23, wherein said groove is of T-shape.
